(19) United States
(12) Patent Application Publication
(10) Pub. No.: US 2020/0158485 A1
(43) Pub. Date: May 21, 2020

(54) Multi function gauges which expand the uses of carpenters steel squares

(71) Applicant: Lawrence David Braddock, Los Angeles, CA (US)

(72) Inventor: Lawrence David Braddock, Los Angeles, CA (US)

(21) Appl. No.: 16/350,477

(22) Filed: Nov. 20, 2018

(51) Int. Cl. G01B 3/56; B43L 7/02

(52) U.S. Cl. CPC G01B 3/566; B43L 7/02

(57) ABSTRACT

A multi-function pair of square gauges for a steel square, the more common of which are referred to as framing or rafter squares. The square gauges give the steel square 90 degree abutments which are in precise vertical alignment with the square blades vertical edge, which essentially turn a carpenter's square into a try square. They also give the square ledges which self-support the square when in normal use. They can also be positioned on the square as a length or depth gauge for marking framing stud layout or repetitive cut lines, and can also be positioned as an improved set of stair or rafter gauges.

### CROSS REFERENCED TO RELATED APPLICATIONS

Cross referenced to Provisional Patent Application No. 62/708,404 filing date 12/08/17 of Lawrence David Braddock.

### STATEMENT REGARDING FEDERALLY SPONSERED RESEARCH AND DEVELOPMENT

Non Applicable

### REFERENCE TO SEQUENCE LISTING, A TABLE, OR A COMPUTER PROGRAM LISTING COMPACT DISC APPENDIX

Non Applicable

### BACKGROUND OF THE INVENTION

The invention generally relates to USPC class 033, Geometrical instruments, and more specifically to subclass 474, Plural straightedges nonadjustably fixed at right angles (e.g., T-square, triangles, squares) and to accessories for steel squares which expand their functions.

### BRIEF SUMMARY OF THE INVENTION

The invention has a slot which accepts the edge of a steel square and has two vertical abutments located above and below said slot and a horizontal ledge aligned with said slot.

A pair of the inventions attached to a steel square allow greater ease and precision in marking or checking 90 degrees by giving it a pair of abutments both above and below the leg of the square which are precisely aligned with the vertical edge of the leg of the square, essentially giving the steel square attributes of a try square. The said abutments abut the vertical linear edge of the lumber, easily aligning the vertical edge of the leg of the square with the vertical edge of the lumber, and the horizontal ledges rest upon the horizontal surface of said lumber, supporting said leg of the square.

A pair of the inventions can also be attached to the square in various positions to precisely mark or check angles, such as but not limited to, rafter ends and tread and riser cut marks on stair jacks.

### BRIEF DESCRIPTION OF THE SEVERAL VIEWS OF THE DRAWINGS

FIG. 1 is a cross section of a square gauge.

FIG. 2 is a cross section of a square gauge with a square's blade located in the slot of the square gauge.

FIG. 3 is a perspective view of a square gauge with a square's blade located in the slot of the square gauge.

FIG. 4 is a cross section of a square gauge with a square's blade located in the slot of the square gauge, and located on a piece of lumber.

FIG. 5 is a plan view of a pair of square gauges attached to a square configured for marking 90 degree angles.

FIG. 6 is a plan view of a pair of square gauges attached to a square configured for the purpose of marking predetermined angles on lumber, such as but not limited to rafter end cuts.

FIG. 7 is a plan view of a pair of square gauges attached to a square for the purpose of marking the tread and riser cuts on stair jacks precisely and repetitively.

### DRAWINGS REFERENCE NUMERALS

10 Square Gauge
12 Ledge
14 Slot
16 Upper Abutment
18 Lower Abutment
20 Square's Blade
22 Square
24 Lumber

### DETAILED DESCRIPTION OF THE INVENTION

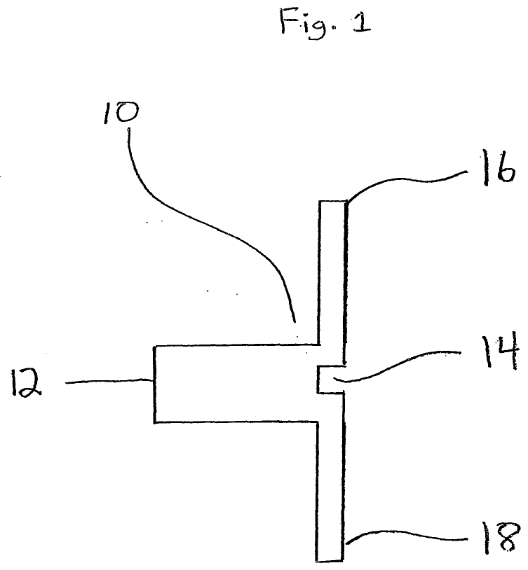

FIG. 1 is a cross section of the square gauge 10 having a ledge 12, a slot 14, an upper abutment 16, and a lower abutment 18. The surfaces of the upper abutment 16 and the lower abutment 18 near the ledge 12 are in precise planar alignment with the vertical edge of the slot 14.

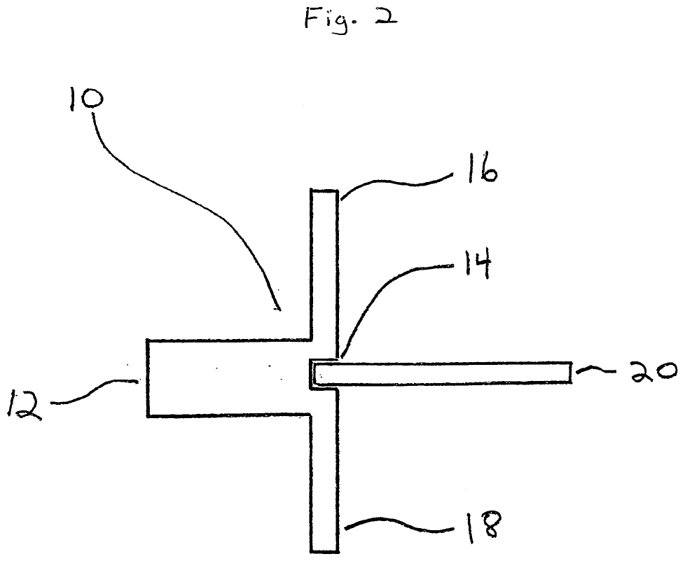

FIG. 2 is a cross section of the square gauge 10 with a square's blade 20 located in the slot 14.

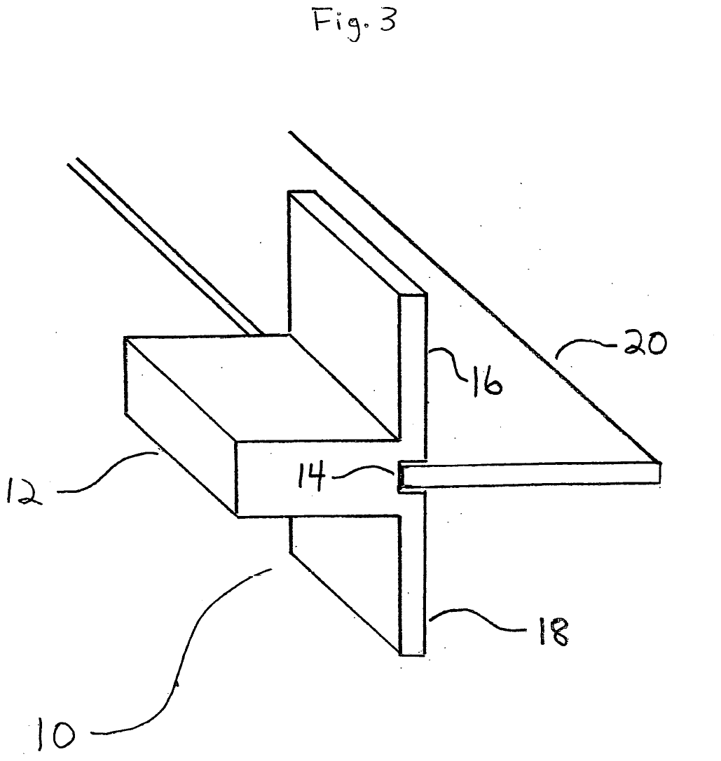

FIG. 3 is a perspective view of the square gauge 10 with a square's blade 20 located in the slot 14.

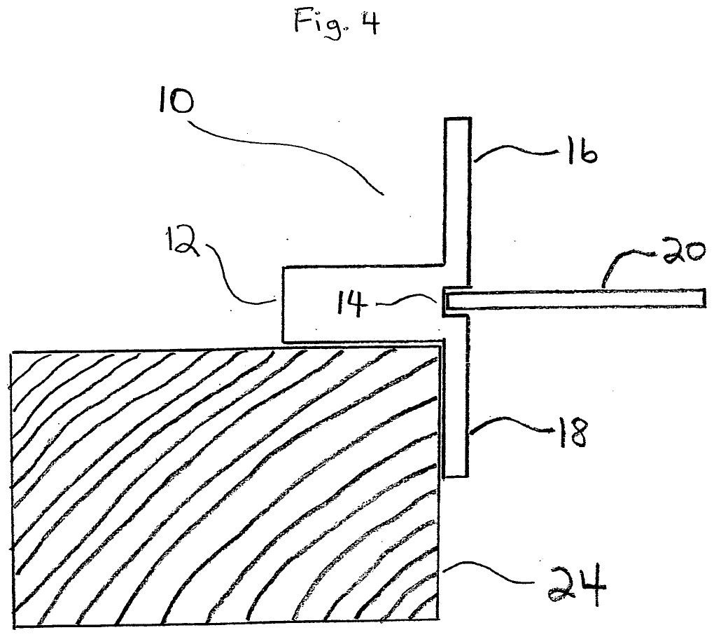

FIG. 4 is a cross section of a square gauge 10 with a square's blade 20 located in the slot 14 with the ledge 12 resting on a piece of lumber 24 and the lower abutment 18 abutting the vertical edge of the lumber 24.

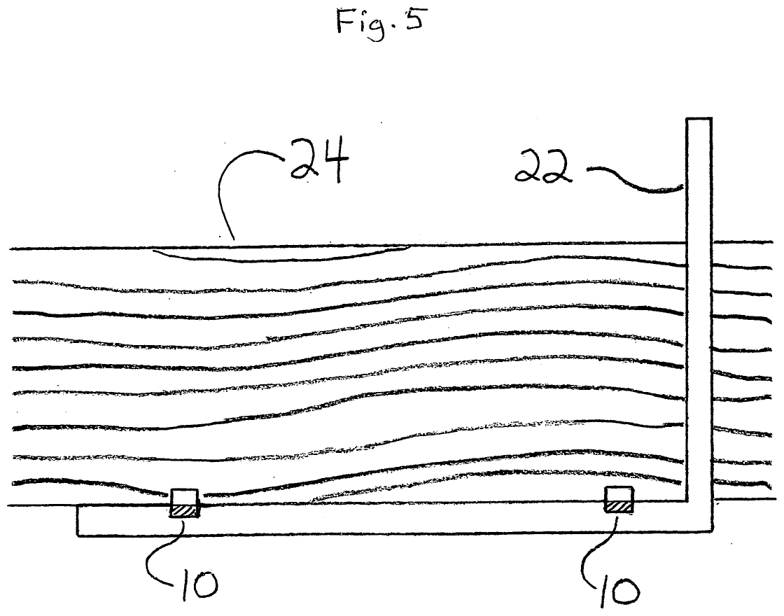

FIG. 5 is a plan view of a pair of square gauges 10 attached to a square 22 for the purpose of aligning one blade of the square 22 at 90 degrees from the linear edge of lumber 24

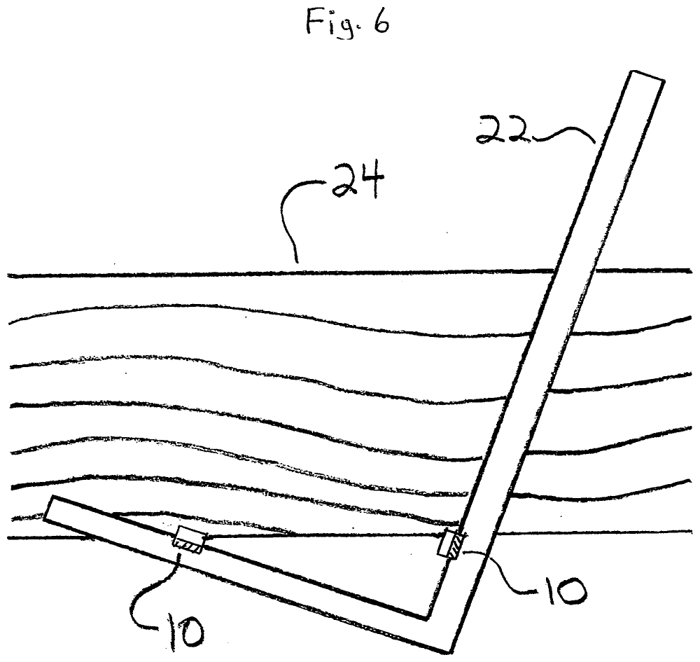

FIG. 6 is a plan view of a pair of square gauges 10 attached to a square 22 for the purpose of marking angled cut lines such as but not limited to rafter end cuts.

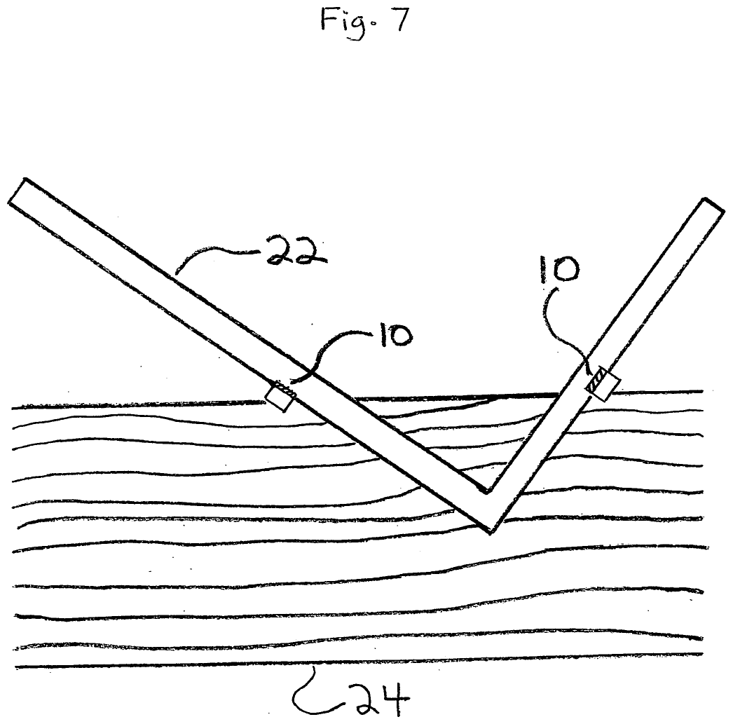

FIG. 7 a plan view of a pair of square gauges 10 attached to a square 22 for the purpose of marking each tread and riser cut precisely on lumber 24 to create a stair jack.

### Operation

FIGS. 5, 6, and 7 show the multiple combinations of the placement of the square gauges 10. FIG. 5 shows that the upper abutments 16 and lower abutments 18 of the pair of gauges 10 essentially turn a steel square into a try square. The ledges 12 also support the leg of the square 22 overhanging the lumber so the workman can let go of it. In addition, either gauge 10 can be set a precise distance from the 90 degree blade of the square 22 and be used as a marking gauge for marking repetitive distances, as in framing, stud placement markings 16″ apart, or cut lines for standard length blocking between studs.

In FIG. 7 you'll notice that the sides of the ledges 12 are at a 90 degree angle from the square's blade 20 and so can be used to make a short mark for the next tread or riser for precise placement of cut lines.

The manufacture of the square gauge 10 can be accomplished by a number of means, such as but not limited to, casting, injection molding, forming into required shapes, or extruding of multiple rigid materials, such as but not limited to aluminum or other metals, or the various plastics, with any extrusions then cut to a desired length as needed. The body of a finished square gauge 10 can be of a single piece, or as two or more assembled pieces.

I claim:

1. A carpenter's square gauge used singly or in pairs comprising:
a. a slot that accepts the vertical edge of a squares blade,
b. supplying said squares blade a ledge which rests upon the horizontal surface of the lumber being squared and so supporting said squares blade without having to be held manually in place by the user,
c. with vertical abutments both above and below said ledge, either one of which abuts the vertical edge of the material being squared regardless of which horizontal surface of said square is in contact with said horizontal surface of said lumber being squared, with
d. the abutting surfaces of said abutments being in precise vertical alignment with the vertical face of said slot which accepts the vertical edge of said squares blade, causing said vertical edge of said material being squared and said vertical edge of said squares blade being in precise vertical alignment.
